(19) United States
(12) Patent Application Publication
(10) Pub. No.: US 2024/0055911 A1
(43) Pub. Date: Feb. 15, 2024

(54) WIRELESS DEVICE CHARGING APPARATUS AND METHOD

(71) Applicant: DISH Ukraine LLC, Kharkiv (UA)

(72) Inventors: Denis Filatov, Kharkiv (UA); Ekaterina Filatova, Kharkiv (UA)

(21) Appl. No.: 18/258,056

(22) PCT Filed: Dec. 18, 2020
(86) PCT No.: PCT/UA2020/000106

§ 371 Date: Jun. 16, 2023

(51) Int. Cl. H02J 50/90; H02J 50/00; H02J 7/00

(52) U.S. Cl. CPC H02J 50/90; H02J 50/005; H02J 7/0044

(57) ABSTRACT

Wireless device charging systems, methods, and non-transitory, machine-readable media are provided. A mobile receptacle may form a cavity adapted to receive a wireless device. A device charger may be disposed along surfaces of the mobile receptacle. The device charger may include coils, a power storage to energize the coils when the device charger operates in a charging mode, and interface ports configured to electrically connect to a power charging source. The device charger may be configured to detect when the wireless device is disposed in a charging position within the cavity, to operate in a charging mode to use the power storage to charge the wireless device consequent to the detecting that the wireless device is disposed in the charging position, to detect when the wireless device is removed from the cavity, and to transition to a non-charging mode consequent to the detecting that the wireless device is removed.

### BACKGROUND

The present disclosure relates in general to battery charging, and, more specifically, but not by way of limitation, to wireless device charging apparatus and methods.

Currently, charging smartphones and other mobile devices can be a hassle. Dealing with charging cords and charging bases can be cumbersome, tedious, and time-consuming. Moreover, dealing with conventional wireless chargers can likewise be inconvenient, limiting, and lacking in helpful features. There is a need for solutions to address such problems and related problems in manners suitable for modern consumer activity patterns.

### BRIEF SUMMARY

Certain embodiments of the present disclosure relate in general to battery charging, and, more specifically, but not by way of limitation, to wireless device charging apparatus and methods.

In one aspect, a wireless device charging system to charge a wireless device is disclosed. The wireless device charging system may include one or a combination of the following. A mobile receptacle may form a cavity adapted to at least partially receive a wireless device. A device charger may be adapted to be disposed along one or more surfaces of the mobile receptacle. The device charger may include one or more coils. The device charger may include a power component including a power storage, the power component to energize the one or more coils when the device charger operates in a charging mode. The device charger may include one or more interface ports configured to electrically connect to a power charging source to facilitate charging of the power storage. The device charger may be configured to detect when the wireless device is disposed in a charging position within the cavity. The device charger may be configured to operate in a charging mode to use the power storage to charge the wireless device consequent to the detecting that the wireless device is disposed in the charging position. The device charger may be configured to detect when the wireless device is removed from the cavity. The device charger may be configured to transition to a non-charging mode consequent to the detecting that the wireless device is removed from the cavity.

In another aspect, method is disclosed that may include one or a combination of the following. A device charger may be configured with one or more coils; a power component including a power storage, the power component to energize the one or more coils when the device charger operates in a charging mode; and one or more interface ports configured to electrically connect to a power charging source to facilitate charging of the power storage. The device charger may be disposed along one or more surfaces of a mobile receptacle, where the mobile receptacle forms a cavity adapted to at least partially receive a wireless device. The device charger may be configured to detect when the wireless device is disposed in a charging position within the cavity. The device charger may be configured to operate in a charging mode to use the power storage to charge the wireless device consequent to the detecting that the wireless device is disposed in the charging position. The device charger may be configured to detect when the wireless device is removed from the cavity. The device charger may be configured to transition to a non-charging mode consequent to the detecting that the wireless device is removed from the cavity.

In yet another aspect, one or more non-transitory, machine-readable media are disclosed and have machine-readable instructions thereon which, when executed by one or more processing devices, cause the one or more processing devices to perform one or a combination of the following. When a wireless device is disposed in a charging position within a cavity of a mobile receptacle may be detected, where the mobile receptacle forms a cavity adapted to at least partially receive the wireless device. A device charger may be operated in a charging mode to use a power storage to charge the wireless device consequent to the detecting that the wireless device is disposed in a charging position. The device charger may include one or more coils; a power component comprising the power storage, the power component to energize the one or more coils when the device charger operates in the charging mode; and one or more interface ports configured to electrically connect to a power charging source to facilitate charging of the power storage. The device charger may be disposed along one or more surfaces of the mobile receptacle. When the wireless device is removed from the cavity may be detected. The device charger may transition to a non-charging mode consequent to the detecting that the wireless device is removed from the cavity.

In various embodiments, the device charger may be disposed within one or more portions of the mobile receptacle. In various embodiments, the mobile receptacle may be formed to include a first charger compartment and a second charger compartment disposed generally opposite of the first charger compartment with respect to the cavity. The device charger may be disposed within the first charger compartment and the second charger compartment. In various embodiments, the device charger may include a first coil and a second coil. In various embodiments, the first coil and the second coil may be disposed in an opposing arrangement, where the first coil is disposed at a first portion of the mobile receptacle and the second coil is disposed at a second portion of the mobile receptacle that is generally opposite of the first portion with respect to the cavity. In various embodiments, the charging position within the cavity may correspond to the wireless device being partially disposed within the cavity. In various embodiments, the charging position within the cavity may correspond to the wireless device being fully within the cavity.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. When only the first reference label is used in the specification, the description is applicable to any one of the similar components having the same first reference label irrespective of the second reference label.

FIG. 1A illustrates a perspective view of a wireless device charging system with a wireless device, in conformance with certain embodiments according to the present disclosure.

FIG. 1B illustrates an end view of the wireless device charging system, in conformance with certain embodiments according to the present disclosure.

FIG. 2 illustrates a block diagram of a device charger, in conformance with certain embodiments according to the present disclosure.

FIG. 3 illustrates an example method for charging a wireless device, in conformance with certain embodiments according to the present disclosure.

FIG. 4 illustrates a computer system, in accordance with certain embodiments of the present disclosure.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Certain embodiments according to the present disclosure may provide for a wireless device charging system that is portable and mobile, not bulky, and that provides a solution for cumbersome, restrictive, and time-consuming charging with cords and stationary charging. Some embodiments of the wireless device charging system may include a wireless charging pocket configured to receive wireless devices and automatically charge wireless devices positioned in the wireless charging pocket. In various embodiments, the wireless device charging system may provide for not only charging of wireless devices, but also monitoring of, control of, and/or communications with the wireless devices.

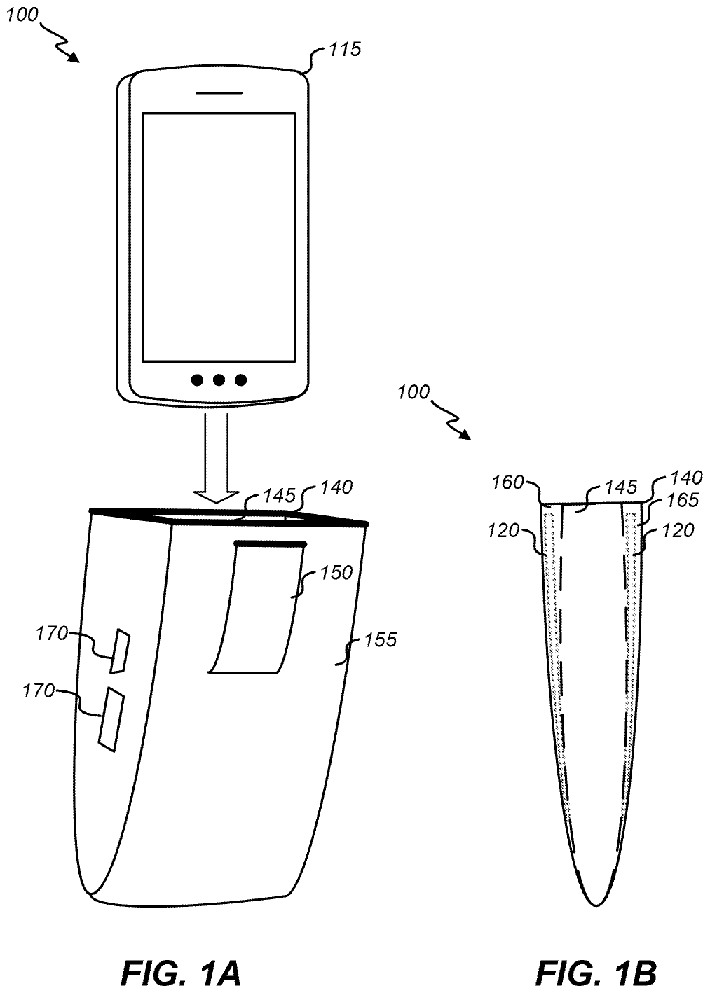

Various embodiments will now be discussed in greater detail with reference to the accompanying figures, beginning with FIG. 1A and FIG. 1B.

FIG. 1A illustrates a perspective view of a wireless device charging system 100 with a wireless device 115, in accordance with certain embodiments of the present disclosure. FIG. 1B illustrates an end view of the wireless device charging system 100, in accordance with certain embodiments of the present disclosure. For brevity, wireless device charging system 100 is depicted in a simplified and conceptual form, and may generally include more or fewer components and features. Further, the number and types of features or elements incorporated within the system 100 may or may not be implementation-specific.

The wireless device charging system 100 may correspond to a system configured to charge the wireless device 115. The wireless device charging system 100 may include a receptacle 140 that is mobile/portable such that it is a mobile receptacle 140. The receptacle 140 may form an aperture and a cavity 145 adapted to at least partially receive the wireless device 115. As in the illustrated example, the wireless device 115 may correspond to one or a combination of a mobile phone, a smart phone, a tablet, an ereader, a personal digital assistant, and/or the like. In other examples, the wireless device 115 may correspond to one or a combination of a wearable computing/communication device (e.g., smartwatches, smart glasses, wearable fitness, health, and/or lifestyle monitors, and/or the like), earbuds, earphones, headsets, audio accessories, music players, handheld gaming consoles, cameras, tools, toys, rechargeable batteries, portable appliances, and/or the like rechargeable devices.

The receptacle 140 may be formed of any suitable material, such as a plastic material, such as a synthetic or semi-synthetic organic material, a nylon-based material, etc. sufficiently structurally sound to form a rigid, semi-rigid, or more flexible receptacle 140. With some embodiments, the receptacle 140 may be formed of a transparent material. In embodiments where the receptacle 145 and the device charger 120 is adapted to be flexible, the material of the receptacle 145 may be selected for its flexibility characteristics and may correspond to a flexible plastic, rubber, fabric, and/or polymer-based material. Likewise, the larger components of the device charger 120 may be selected for their flexibility characteristics, which components may include, for example, a flexible battery as the power storage, one or more flexible coils, flexible conductors, and polymer-based film, insulation, and coatings. For example, the device charger 120 may include one or more substrates, which could be one or more printed circuit boards, flex circuits, flexible printed circuit boards, flex print, or any other substrate suitable for carrying certain components of the device charger 120. Other components of the device charger 120 may be selected to be sufficiently small in size to still allow for flexibility of the overall device charger 120. Such components may include, for example, a chipset (one or more integrated circuits may provide certain functionalities, such as those of the charger controller disclosed herein) sensors (e.g., a thermal protection sensor and/or other sensors disclosed herein), display components (e.g., a low-power LED, an ink display, etc.), a vibration motor, and/or the like. The degree of flexion allowed by the flexibility characteristics of the receptacle 145 and device charger 120 may be limited to, for example, 30° from a reference plane, or any other suitable angle. The flexibility of the system may allow for increased freedom of movement, comfort, and resiliency when, for example, the system is placed within a pants pocket.

In some embodiments, the receptacle 140 may be sized to at least partially receive the wireless device 115. In some embodiments, the receptacle 140 may be sized to fully receive the wireless device 115 so that the, when the wireless device is in a fully received state, the wireless device is disposed in a charging position within a cavity 145 of the receptacle 140. The receptacle 140 may be sized and configured to receive in charge a variety of different sizes of wireless devices 115 such that, even if a wireless device 115 does not fully fit into the cavity 145, the wireless device 115 may still partially fit into a charging position within the cavity 145 and be charged effectively.

In some embodiments, the receptacle 140 may be sized to form fit the wireless device 115. In such embodiments, the form fit may provide for a friction fit such that the contact between the receptacle 140 and the wireless device 115 has suitable tightness over a suitable amount of surface area in order to secure the wireless device 115 in the cavity 145 when the wireless device 115 is placed therein so that the wireless device 115 remains in the cavity 145 under various handling conditions and forces. For example, when the receptacle 140 is turned so that the aperture of the cavity 145 is facing downward, the wireless device 115 may remain secured in the cavity 145 despite the force of gravity on the wireless device 115. Instead, to release the wireless device 115 from the friction fit of the receptacle 140, a user may apply a suitable amount of pulling force to remove the wireless device 115 from the cavity 145.

While the receptacle 140 may be sized to receive a particular type of wireless device 115 with a form fit, it may be adaptable such that other types of wireless devices 115 may also be placed in the cavity 145. The sloping interior surfaces of the cavity 145 may adapted to accommodate a variety of sizes of wireless devices 115, while still providing friction fits for the devices 115. Further, the form and shape of the receptacle 140 illustrated is merely exemplary. Other embodiments of the receptacle 140 may have different forms and shapes. In some embodiments, the receptacle 140 may be a multi-piece receptacle with multiple pieces pivotally interconnected (e.g., two clamshell-like pieces may be pivotally interconnected via a hinge assembly) and may fasten into the form of the depicted receptacle 140 (e.g., via snap latch assembly with mating portions configured to releasably latch the two pieces together).

The receptacle 140 may, in some examples, have the form and shape such that the receptacle 140 corresponds to a pocket. Accordingly, the wireless device charging system 100 may correspond to a wireless charging pocket in some embodiments. In some embodiments, the receptacle 140 may be dimensioned as a pocket that may fit within another pocket, such as a pants pocket, a hoodie pocket, a shirt pocket, a backpack pocket, a shirt pocket, a Fanny pack pocket, duffle bag pocket, and/or the like. In some embodiments, though not depicted, the receptacle 140 may be formed to have one or more curves that match one or more curves of the human body (e.g., curves of the leg, hip, buttock, arm, back, etc.). For example, in various embodiments, side 155 (and/or the opposing side) of the receptacle 140 may be curved in a partial cylindrical or quasi-cylindrical form in any suitable manner.

Further, some embodiments of the receptacle 140 may include one or more quick-release fasteners 150 to facilitate attachment to an article of clothing and/or a component of a container such as a backpack, purse, Fanny pack, duffle bag, and/or the like. The one or more quick-release fasteners 150 may allow the receptacle 140 to be attachable and detachable from the clothing articles and/or container components. According to some embodiments, a quick-release fastener 150 may correspond to any suitable fastener that allows the receptacle 140 to be attachable and detachable from the clothing articles and/or container components. Various embodiments of a quick-release fastener 150 may include a snap clip, a magnetic fastener, a ring clip, a snap button, a hook and loop fastener (which could employ a plurality of hooks and loops), and/or the like.

The wireless device charging system 100 may include a device charger 120 adapted to be disposed along one or more surfaces of the receptacle 140. In some embodiments, the device charger 120 may be disposed within one or more portions of the receptacle 140. In various embodiments, the device charger 120 may be disposed within, partially within, or otherwise along one or more walls of the receptacle 140. The illustrated example depicts the device charger 120 within walls of the receptacle 140. The receptacle 140 may include one or more charger compartments. For example, a first charger compartment 160 may be formed on one side of the cavity 145. In some embodiments, a second charger compartment 165 may be formed on another side of the cavity 145. For example, the second charger compartment 165 may be disposed generally opposite of the first charger compartment 160 with respect to the cavity 145. In some embodiments, one or more charger compartments may be adapted to be accessible, e.g., with a snap fastener, snap latch assembly, or the like. In various embodiments, the device charger 120 may be disposed within the first charger compartment 160 and/or the second charger compartment 165. Accordingly, in some embodiments, the first charger compartment 160 and the second charger compartment 165 may correspond to a first charger circuit compartment 160 and a second charger circuit compartment 165, respectively, with the second charger circuit compartment 165 electrically interconnected with the first charger circuit compartment 160.

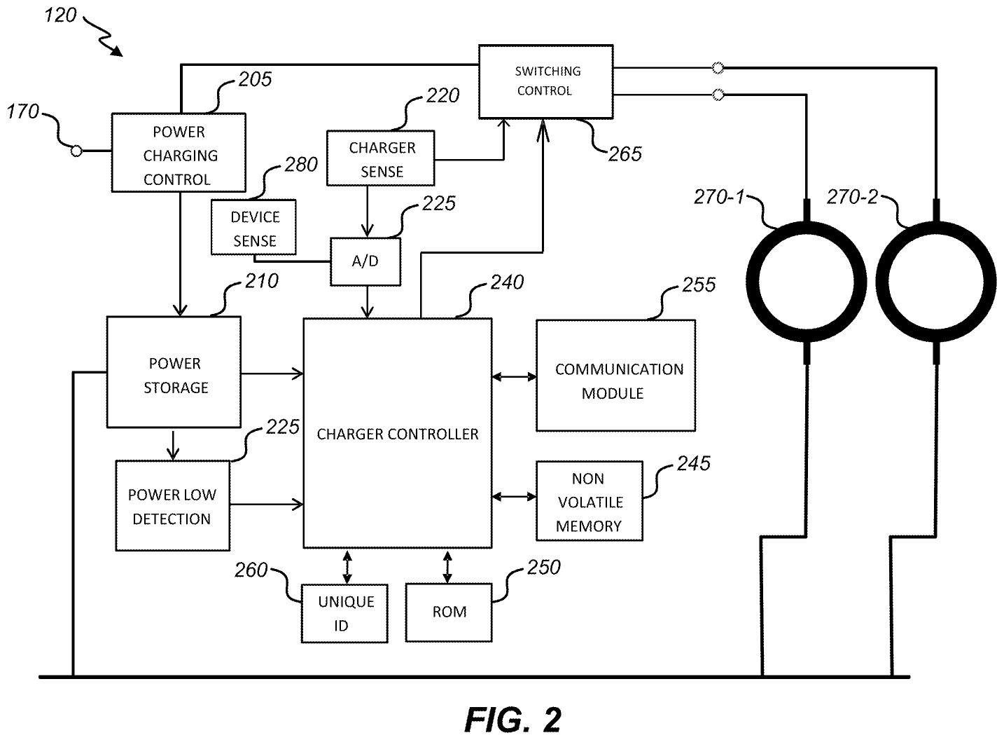

FIG. 2 illustrates a block diagram of the device charger 120, in accordance with certain embodiments of present disclosure. As disclosed herein, the device charger 120 may include one or more coils 270. The illustrated example includes the first coil 270-1 and the second coil 270-2. The device charger 120 may include a switching component 265. The switching component 265 may be electrically coupled to one or more terminals for individual and selective switching control of current to/from the coils 270. In some embodiments, the switching component 265 may include a first current switch for individual and selective switching control of current to/from the first coil 270-1 and a second current switch for individual and selective switching control of current to/from the second coil 270-2. Each of the switches 265 may include a suitable relay, semiconductor switch (e.g., a thyristor or TRIAC), and/or the like that can enable or disable power flow, and otherwise limit the flow of current (e.g., by only switching on for a certain part of each cycle, which part may be varied to vary the limitation). As disclosed herein, the device charger 120 may include a power storage 210. The device charger 120 may be electrically couplable to a power charging source 205 to enable recharging of the internal power storage 210. In some embodiments, one or more resistive elements in series with the switches 265 may limit the current to lower amounts. The current would be limited to a value that is just sufficient to charge the storage cell. The resistive element may be programmable in value with further switches to allow for the current to be varied.

In some embodiments, the first charger circuit compartment 160 may include the first coil 270-1, and the second charger circuit compartment 165 may include the second coil 270-2. Accordingly, the first coil 270-1 and the second coil 270-2 may be disposed in an opposing or generally opposing arrangement, where the first coil 270-1 is disposed at a first portion of the mobile receptacle 140 and the second coil 270-2 is disposed at a second portion of the mobile receptacle 140 that is opposite or generally opposite of the first portion with respect to the cavity 145. The coils 270 may be oriented so that axes of the coils 270 are aligned or generally aligned, with opposite or the same pole directions in various embodiments. This may allow for symmetrical charging capabilities such that charging components on each side of the receptacle 140 may cooperatively charge a wireless device 115 that is positioned between the first charger compartment 160 and the second charger compartment 165. Thus, a wireless device 115 may be disposed in multiple charging positions within the cavity 145 and the multi-coil configuration with an opposing coil arrangement may allow for bidirectional charging adaptability. For example, the wireless device 115 illustrated in FIG. 1 may be disposed in a charging position with its screen facing the direction shown, with its screen facing in the opposite direction, inverted vertically as opposed to the orientation illustrated, etc.

In some embodiments, the receptacle 140 may include one or more connectors 170 for connection for power and/or communication to one or more power sources and/or computer devices in order to charge up the power storage 210 (illustrated in FIG. 2) of the device charger 120. The one or more connectors 170 may include one or a combination of USB ports of any suitable version and type (e.g., standard, micro, mini, and/or the like), a jack plug, and/or any other shape, size, standard, and type of suitable connector for power and/or communication to facilitate the features disclosed herein. With the one or more connectors 170 electrically connected to other portions of the device charger 120 with conductors extending through the casing of the receptacle 140, the device charger 120 may be powered up via the one or more connectors 170 and power connection to a power source. Further, in some embodiments, the device charger may be connected via the one or more connectors 170 to a computing device to facilitate communications, transfer of data, and the like to facilitate features disclosed herein.

The charger controller 240 may be the main intelligence responsible for monitoring and controlling all operations within the device charger 120. The charger controller 240 may be powered by the power storage 210. The charger controller 240 may include a microprocessor with programming instructions stored in any suitable form of non-volatile memory 245. The charger controller 240 could include dedicated logic circuits programmed to detect and respond to defined input conditions.

The device charger 120 may include a power detector 225 configured to monitor the voltage being stored in the device charger 120. The power detector 225 may be communicably coupled with the charger controller 240. The power detector 225 may detect when the voltage starts to drop to indicate the decreased voltage to the charger controller 240. The device charger 120 may also send a message to the wireless device 115 when the power storage 210 is getting low and/or critically low so that the user may be informed.

The device charger 120 may include one or more charger sensors 230. For example, the one or more charger sensors 230 may include a current sensor that may be configured to monitor the current flow. The current sensor 230 may use a low-impedance resistive element which generates a voltage across it proportional to the current flowing through one or more portions of the charger 120, such as through the conductor electrically connected to the coils 270. Likewise, the one or more charger sensors 230 may include a thermal protection sensor. The thermal protection sensor 230 may generate a voltage that is proportional to the temperature of the charger 120. Each of these voltages may be converted using an A/D converter 235 or a similar converter into a digital representation. As well as providing information relating to the instantaneous current flow, this may also allow synchronization of functionality with cycles of AC mains. The A/D converter 235 may require a high resolution to cope with the wide variation in load currents and also to be fast, as it must respond to the alternating mains cycle and rapidly to fault conditions. The output of the A/D converter 235 may be fed as a digital word to the charger controller 240. The charger controller 240 may read the digital input values to determine the characteristics indicated by the sensors and may initiate operations accordingly. For example, the charger controller 240 may use the detections of current in order to facilitate the various charging features disclosed herein. Likewise, the charger controller 240 may monitor detected temperatures of the charger 120, receptacle 145, and/or device 115 and may compare monitored values against one or more thresholds for operation of the device charger 120. If one or more of the thresholds are exceeded, the charger controller 240 may implement charging throttling disclosed herein to downshift charging operations in an effort to decrease detected temperatures. Further, the charger controller 240 may terminate charging operations if a certain threshold is exceeded temperature. If the threshold-exceeding condition continues, then the device charger 120 may be transition to default off. Thus, the device charger 120 may trigger a fault situation or adaptive operating modes to address temperature conditions. Consequent to detections of one or a combination of the sensed characteristics disclosed herein, the charger controller 240 may cause transmission of corresponding messages to the wireless device 115, indicating the sensed characteristics and/or corresponding events.

The power storage 210 may include one or more battery cells, one or more capacitors, and/or a similar charge storage device. The power storage 210 may have sufficient capacity to charge the wireless device 115 and allow for communications and other operations of the device charger 120 for long periods of time. In some embodiments, the power storage 210 of the device charger 120 may correspond to replaceable and/or rechargeable battery. Certain embodiments may allow for removal of the power storage 210 and recharging it in an external adapter. The power storage 210 may be charged by an external power source, such as mains power via an electrical power outlet and a wired connection. The power charging control circuitry 205 may be configured to control the amount of current flowing from the external power source with a power generation circuit and/or transformer circuit of the power charging control 205. Additionally or alternatively, in some embodiments, the power storage 210 may be wireless charged by another wireless charger base and/or shelf by way of inductive coupling. To that end, the device charger 120 may include wireless charge receiving circuitry and components, including a receiver induction coil and charging chipset, to itself be charged wirelessly. In some embodiments, the device charger 120 may be configured so that the same one or more coils 270 may be used as receiver coils when the device charger 120 is being wirelessly charged by another wireless charger base and/or shelf.

In some embodiments, the rechargeable battery 210 may be detachable from one of the compartments of the receptacle 140 in order to allow the battery to be removed and placed in a charging cradle, on a charging base or shelf, and/or the like. Additionally or alternatively, in some embodiments, the system may include a solar cell charger that may be connected to the device charger 120. The solar cell charger may include a solar panel and an internal rechargeable battery in order to capture solar energy on the exterior of the receptacle 140 or of a backpack, duffel bag, purse, etc. for example, the solar cell charger may be clipped (e.g., with a carabiner clip) to an exterior portion of a backpack in order to capture solar energy when exposed to some. In such a scenario, the solar cell charger may be concurrently or subsequently be connected via wire connection to the device charger 120 in order to recharge the power storage 210 of the device charger 120. Accordingly, the device charger 120 may be placed on an interior of a backpack, while the placed on the exterior thereof. In some embodiments, the solar cell charger and the receptacle 140 may be integrated so that both may be attached to an exterior of a backpack, duffle bag, etc.

The device charger 120 may be configured to detect when the wireless device 115 is disposed in a charging position within the cavity 145. Consequent to such detection, the wireless device charger 120 may wake from a low-power mode and initiate charging operations. Induction coils 270 of the device charger 120 and the wireless device 115 may generate an electromagnetic field that transfers energy from the device charger 120 to the wireless device 115. Accordingly, the device charger 120 may operate in a charging mode to use its power storage 210 to charge the wireless device 115 consequent to the detecting that the wireless device 115 is disposed in the charging position.

In various embodiments, the low-power mode may correspond to a monitoring mode or a powered down, off state. In either case, such detection may be facilitated by the one or more induction coils 270 of the device charger 120 detecting one or more induction coils of the wireless device 115 when the induction coils are within range by detecting one or more changes in the inductance and/or related characteristics of the device charger 120 with any suitable metrics and/or characteristics corresponding to the changes resulting from the introduction of the induction instance of the electromagnetic coupling of the coils. With electrical power being provided to the one or more coils 270 of the device charger 120, the electrical power may be converted and transmitted through magnetic induction. The charging operations may correspond to tightly-coupled electromagnetic inductive charging or loosely-coupled resonant charging in various embodiments. Additionally or alternatively, the detection of when the wireless device 115 is disposed in a charging position within the cavity 145 may be facilitated by the device charger 120 wirelessly communicating with the wireless device 115 and receiving communications indicating the wireless device 115 is charging when the device charger 120 is operating in (e.g., a low-power) charging mode and the wireless device 115 has been positioned in proximity to the device charger 120.

The device charger 120 may likewise detect a change in the induction characteristics that corresponds to the wireless device 115 ceasing and/or decreasing taking charge/drawing current from the device charger 120. Additionally or alternatively, the detection of when the wireless device 115 is disposed in a charging position within the cavity 145 may be facilitated by the device charger 120 using one or more sensors 280, which may include one or more pressure sensors, contact sensors, proximity sensors, reed switches, light sensors, and/or the like configured to detect the presence of the wireless device 115 within the cavity 145 and trigger the device charger 122 charge the wireless device 115. The device charger 120 may include or otherwise communicatively coupled to the one or more sensors 280. Consequent to the one or more sensors 280 detecting the wireless device 115 disposed in a charging position within the cavity 145, the charger controller 240 may receive the sensor input as disclosed herein and may initiate charging operations to begin charging the wireless device 115. Likewise, the device charger 120 may detect when the wireless device 115 has been removed from a charging position within the cavity 145. Consequent to the detecting that the wireless device 115 has been removed from the cavity 145, the wireless device charger 120 may transition to a non-charging mode, which may include ceasing charging operations and initiating a low-power mode. In this manner, device charger 120 may conserve power until charging operations are again needed with a wireless device 115 having been inserted into the charging position within the cavity 145.

The device charger 120 may include one or more communication modules and interface components which allow the device charger 120 to communicate wirelessly with the wireless device 115, as disclosed further herein. For example, as illustrated in FIG. 2, the device charger 120 may include a communication module 255, which may include any one or combination of Zigbee, Bluetooth, Z-Wave, Wi-Fi, near-field communication, and/or the like RF communication modules which allow the device charger 120 to communicate wirelessly with the wireless device 115. The device charger 120 may be individually identifiable. In some embodiments, an application (e.g., a mobile app) installed on the wireless device 115 may be configured to interface with the device charger 120 to facilitate user input to control the device charger 120 (e.g., to configure it for specific charging modes) and to facilitate surfacing of charging-related information (e.g., a power storage profile). The power storage profile data for an identified wireless device 115 may include data regarding patterns of charging the wireless device 115 such as how long it takes for the device to be fully charged, how the ability for the device to be charged changes over time, the charging curve is a function of time and how that charging curve changes over time, indicia of wireless device battery health which may be inferred from the foregoing observation data, charging curves as a function of time as well as different charging amperage levels, and/or the like. By observing and analyzing the characteristic of charging a particular wireless device 115 over time, certain embodiments may be configured to communicate to the wireless device 115 a warning when the charging characteristic conditions are steadily changing over a period of time. For example, the device charger 120 may provide indication to the wireless device 115 that there is an impending batter failure (or a weakened condition) to cause the wireless device 115 to present a warning (e.g., by way of push notification or the like).

The device charger 120 may include non-volatile memory 245 that may, for example, retain recordings of the power storage of the wireless device 115, which may include storing power storage profile data mapped to a variety of different wireless devices 115 charged with the device charger 120, over time. However, in some embodiments, the data may be stored only for a sufficient time to allow for uploading of the data to the wireless device 115 via the communication module 255. In order to reduce the amount of data that must be sent, the values could be averaged over a period of time, in some embodiments. In the case of a microcontroller-based system, the non-volatile memory 245 may also store operating instructions, and/or they may be programmed in a read-only memory 250.

The wireless device 115 may relay wireless signals to the wireless device charger 120, indicating current power storage status of the wireless device 115. For example, the wireless device 115, or alternatively, the device charger 120, may have a protection chip and/or sensor that monitors its power storage, and, based on the monitoring, the wireless device 115 may communicate the indicia of the current power status (e.g., a percentage of the charge level of the battery) and/or of the charging needs (e.g., any indication that it still needs to be charged or that it does not still need to be charged). Additionally or alternatively, the device charger 120 may detect changes in its circuitry resulting from an increased charge level, a maximum charge level, and/or change in the current flow of the corresponding circuitry of the wireless device 115. For example, the wireless device charger 120 may detect changes in inductance characteristics and/or corresponding characteristics that the device charger 120 may identify as indicative of the changes in charge level and/or current flow in the wireless device 115. The wireless device 115, for example, may disconnect or otherwise stop current flow through its receiver circuitry, which the device charger 120 may be able to detect as the inductance and/or other characteristics of its circuitry change state due to the coupling of the charger and receiver coils. When the device charger 120 has detected one or more state changes that it maps to a decreased charging mode or a cessation of charging operations, the device charger 120 may initiate a low-power mode to conserve power for later full-power charging operations.

The device charger 120 may be configured to monitor power to the wireless device 115. The device charger 120 may be further configured to adaptively control the power flow to the wireless device 115. The device charger 120 may be able to regulate the current and voltage so as to provide a gradient of control beyond binary control of simply powering or not powering the wireless device 115. The wireless device charger 120 may detect state changes in the wireless device 115 in real-time and adapt charging operations as a function of the detected state changes. The wireless device charger 120 may use the indications of current power storage status to control the charging operations. Such control may include stopping charging of the wireless device 115 when the current power storage status of the wireless device 115 is detected to be at maximum capacity. Such control may also include throttling charging of the wireless device 115 is a function of the current power storage status of the wireless device. For example, when the device charger 120 detects that the power storage status is below a particular threshold (e.g., 25%, 50%, etc.), the device charger 120 may operate and fast-charging mode that provides more charging power to the wireless device 115. When the device charger 120 detects the power storage is above the particular threshold, the device charger 120 may throttle down the power to a medium-charging mode that provides less charging power to the wireless device 115. When the device charger 120 detects the power storage is above another particular threshold (e.g., 97% or the like), the device charger 120 may throttle down the power to a slow-charging mode that provides even less charging power to the wireless device 115 (e.g., trickle charge). Various embodiments may employ various thresholds and charging modes. Additionally or alternatively, the device charger 120 may likewise implement such charge throttling as a function of the power level of its power storage 210.

The receptacle 140 and/or the device charger 120 may provide a user interface to allow for output of charging-related information to a user and for input from user with one or more user-selectable options to configure the device charger 120 to operate in different charging modes, for example. In various embodiments, an end-user interface may include providing one or more display screens that may each include one or more user interface elements. An end-user interface may include any image, icons, widgets, buttons, checkboxes, text, text boxes, text fields, tables, lists, and/or the like that can be displayed on a display screen for providing information to a user and/or for receiving user input.

The receptacle 140 and/or the device charger 120 may include input elements may include one or more of a keypad, a trackball, a touchscreen, a touchpad, a pointing device, a microphone, a voice recognition device, or any other appropriate mechanism for the user to provide input. The receptacle 140 and/or the device charger 120 may include a display that may include a resistive or capacitive screen. The display may be configured for stylus sensitivity which allows movement of the stylus on the screen to be detected. The touch-screen capability may be achieved via an electronic position location system capable of determining a location of a selected region of the display screen. A commercially available electronic position location system like the ones that are used in many commercially available devices such as personal digital assistants, tablet PCs, and smartphones, may be used. An exemplary system may comprise a glass or plastic plate with a metallic coating facing a metallic coating on an underside of a layer of Mylar™ above the glass or plastic plate. In various embodiments, the input elements may include one or more of: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

The receptacle 140 and/or the device charger 120 may include a memory (e.g., a non-transitory computer-readable storage medium) communicatively coupled to a processor (e.g., a microprocessor), which may correspond to the charger controller 240 in some embodiments, for processing the functions of the w receptacle 140 and/or the device charger 120. The receptacle 140 and/or the device charger 120 may include at least one antenna for wireless data transfer. The receptacle 140 and/or the device charger 120 may also include a microphone to allow a user to transmit voice communication through the receptacle 140 and/or the device charger 120, and a speaker to allow the user to hear alarms, voice communication, music, etc. In addition, the receptacle 140 and/or the device charger 120 may include one or more interfaces in addition to the antenna, e.g., a wireless interface coupled to an antenna. The communications interfaces of the receptacle 140 and/or the device charger 120 can provide a near field communication interface (e.g., contactless interface, Bluetooth, Zigbee, optical interface, etc.) and/or wireless communications interfaces capable of communicating through a cellular network, such as GSM, or through Wi-Fi, such as with a wireless local area network (WLAN). Accordingly, receptacle 140 and/or the device charger 120 may be capable of transmitting and receiving information wirelessly through both short range, radio frequency (RF) and cellular and Wi-Fi connections. The computer-readable medium coupled to the processor of the receptacle 140 and/or the device charger 120 may which store application programs and other computer code instructions for operating the device, such as an operating system (OS). The computer-readable medium can include a sensing application to gather and/or process any suitable sensor data from sensors in accordance with various embodiments.

As disclosed herein, the device charger 120 may cooperate with the wireless device 115 in order to provide a user interface via the wireless device 115. To that end, the wireless device 115 may be provided with a mobile application configured to run on the wireless device 115 to facilitate various embodiments of this disclosure. In some embodiments, instead of a mobile application, another type of application or instruction set may be configured to run on the wireless device 115 to facilitate various embodiments of this disclosure. The wireless device 115 may be any portable device suitable for sending and receiving information in accordance with embodiments described herein. For example without limitation, in various embodiments, the wireless device 115 may include one or more of a mountable control unit, a mobile phone, a cellular telephone, a smartphone, a handheld mobile device, a tablet computer, a web pad, a personal digital assistant (PDA), a notebook computer, a handheld computer, a laptop computer, or the like. Accordingly, the wireless device 115 may include a display and input elements to allow outputted information to a user and to allow the user to input information into the wireless device 115.

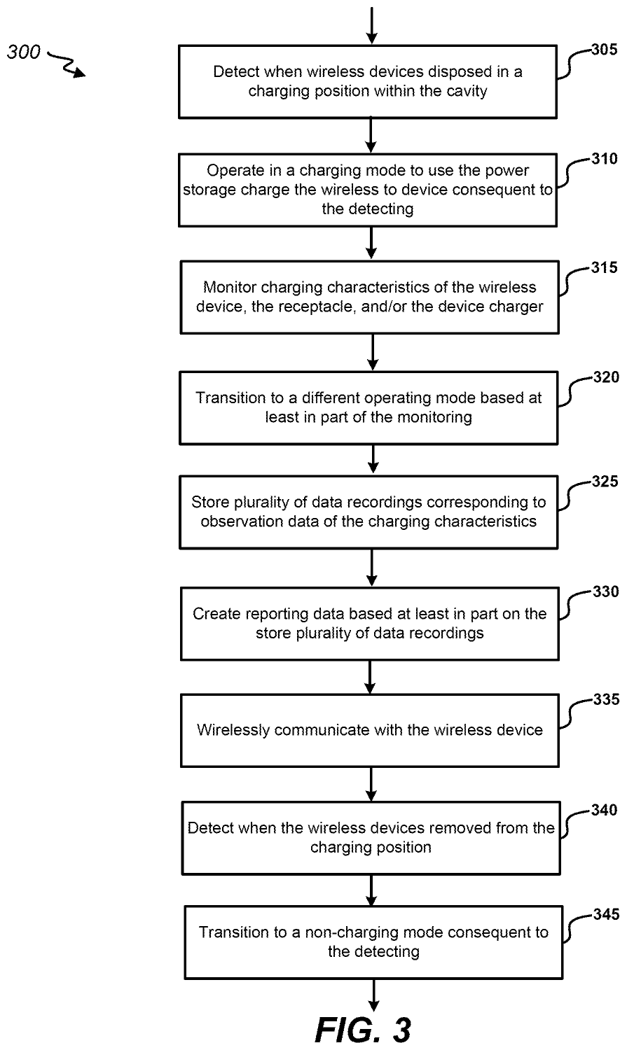

Referring now to FIG. 3, an example method 300 for charging a wireless device, in accordance with embodiments of the present disclosure. Teachings of the present disclosure may be implemented in a variety of configurations that may correspond to the configurations disclosed herein. As such, certain aspects of the methods disclosed herein may be omitted, and the order of the steps may be shuffled in any suitable manner and may depend on the implementation chosen. Moreover, while the aspects of the methods disclosed herein, may be separated for the sake of description, it should be understood that certain steps may be performed simultaneously or substantially simultaneously.

As indicated by block 305, the device charger 120 may detect when the wireless device 115 is disposed in a charging position within the cavity 145. As indicated by block 310, the device charger 120 may operate in a charging mode to use the power storage 210 to charge the wireless device 115 consequent to the detecting that the wireless device 115 is disposed in the charging position. As indicated by block 315, the device charger 120 may monitor one or more charging characteristics of the wireless device 115, the receptacle 140, and/or the device charger 120 itself. In some embodiments, the monitoring may include receiving sensor data from one or more sensors, such as the one or more charger sensors 220 and/or the one or more device sensors 280. Further, in some embodiments, the monitoring may include receiving one or more wireless communications from the wireless device 115, indicating one or more characteristics of the wireless device 115 such as a power storage status, a temperature status, and/or the like.

As indicated by block 320, based at least in part on the monitoring, the device charger 120 may transition to a different operating mode that is different from the initial operating mode corresponding to the charging mode. For example, the device charger 120 may detect a trigger event and respond by transitioning to the different operating mode. As disclosed herein, the various operating modes may include modes corresponding to different charging levels and terminating charging. As indicated by block 325, based at least in part on the monitoring, the device charger 120 may store a plurality of data recordings corresponding to observation data of the charging characteristics of the wireless device 115, the receptacle 140, and/or the device charger 120 over a period of time. As disclosed herein, the device charger 120 may monitor, measure, detect, estimate, and/or otherwise gather information pertaining to charging characteristics and power storage profile characteristics. As indicated by block 330, the device charger 120 may create reporting data based at least in part on the stored plurality of data recordings.

As indicated by block 335, the device charger 120 may wirelessly communicate with the wireless device 115. The wireless communication may include transmitting the reporting data the wireless device 115 and may be based at least in part on a reporting frequency that is a function of change with respect to the observation data. For example, when the observation data is determined by the device charger 120 to be substantially static over a particular time period and/or over one or more charging instances, a lesser reporting frequency may be selected. However, when the observation data is determined by the device charger 120 to be substantially dynamic over a particular time period and/or over one or more charging instances, a greater reporting frequency may be selected. Additionally, in some embodiments, the device charger 120 may provide one or more notifications to the wireless device 115 prior to and/or after an operational mode transition to indicate and create a record of the change. A notification could be provided for all changes or for only select changes.

As indicated by block 340, the device charger 120 may detect when the wireless device 115 is removed from the charging position and/or cavity 145. As indicated by block 345, the device charger 120 may transition to a non-charging mode consequent to the detecting that the wireless device 115 is removed from the cavity 145.

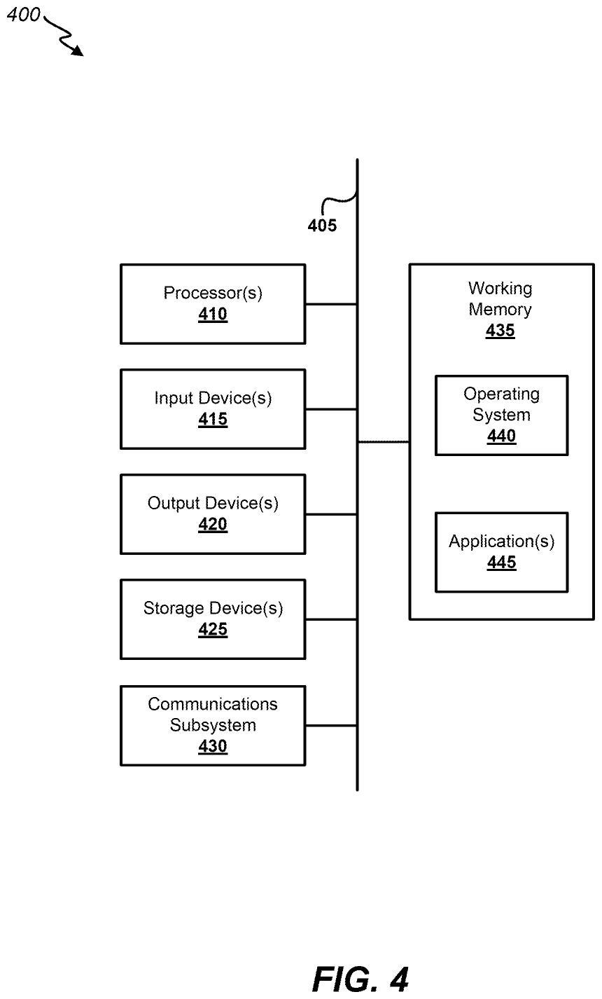

A computer system and/or components thereof as illustrated in FIG. 4 may be incorporated as part of the previously described device charger 120. FIG. 4 provides a schematic illustration of one embodiment of a computer system 400 that can perform various steps of the methods provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, graphics acceleration processors, video decoders, and/or the like); one or more input devices 415, which can include without limitation a mouse, a keyboard, remote control, and/or the like; and one or more output devices 420, which can include without limitation a display device, a printer, and/or the like.

The computer system 400 may further include (and/or be in communication with) one or more non-transitory storage devices 425, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset (such as a Bluetooth™ device, an 802.11 device, a WiFi device, a WiMax device, cellular communication device, etc.), and/or the like. The communications subsystem 430 may permit data to be exchanged with a network (such as the network described below, to name one example), other computer systems, and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 425 described above. In some cases, the storage medium might be incorporated within a computer system, such as computer system 400. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 835 from another computer-readable medium, such as one or more of the non-transitory storage device(s) 825. Merely by way of example, execution of the sequences of instructions contained in the working memory 435 might cause the processor(s) 410 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 (and/or components thereof) generally will receive signals, and the bus 405 then might carry the signals (and/or the data, instructions, etc. carried by the signals) to the working memory 435, from which the processor(s) 410 retrieves and executes the instructions. The instructions received by the working memory 435 may optionally be stored on a non-transitory storage device 425 either before or after execution by the processor(s) 410.

It should further be understood that the components of computer system 400 can be distributed across a network. For example, some processing may be performed in one location using a first processor while other processing may be performed by another processor remote from the first processor. Other components of computer system 400 may be similarly distributed. As such, computer system 400 may be interpreted as a distributed computing system that performs processing in multiple locations. In some instances, computer system 400 may be interpreted as a single computing device, such as a distinct laptop, desktop computer, or the like, depending on the context.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Features described herein with references such as “in some embodiments” and “in certain embodiments” are not intended to be exclusive alternatives to other embodiments; instead, the features described with such references may be combined with other features of other embodiments. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

Furthermore, the example embodiments described herein may be implemented as logical operations in a computing device in a networked computing system environment. The logical operations may be implemented as: (i) a sequence of computer implemented instructions, steps, or program modules running on a computing device; and (ii) interconnected logic or hardware modules running within a computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Also, the terms in the claims have their plain, ordinary meaning unless otherwise explicitly and clearly defined by the patentee. The indefinite articles “a” or “an,” as used in the claims, are defined herein to mean one or more than one of the element that the particular article introduces; and subsequent use of the definite article “the” is not intended to negate that meaning. Furthermore, the use of ordinal number terms, such as “first,” “second,” etc., to clarify different elements in the claims is not intended to impart a particular position in a series, or any other sequential character or order, to the elements to which the ordinal number terms have been applied.

What is claimed:

1. A wireless device charging system to charge a wireless device, the wireless device charging system comprising:
a mobile receptacle that forms a cavity adapted to at least partially receive a wireless device;
a device charger adapted to be disposed along one or more surfaces of the mobile receptacle;
the device charger comprising:
one or more coils;
a power component comprising a power storage, the power component to energize the one or more coils when the device charger operates in a charging mode;
one or more interface ports configured to electrically connect to a power charging source to facilitate charging of the power storage;
the device charger configured to:
detect when the wireless device is disposed in a charging position within the cavity;
operate in a charging mode to use the power storage to charge the wireless device consequent to the detecting that the wireless device is disposed in the charging position;
detect when the wireless device is removed from the cavity; and
transition to a non-charging mode consequent to the detecting that the wireless device is removed from the cavity.

2. The wireless device charging system to charge a wireless device as recited in claim 1, where the device charger is disposed within one or more portions of the mobile receptacle.

3. The wireless device charging system to charge a wireless device as recited in claim 1, where the mobile receptacle comprises:
a first charger compartment; and
a second charger compartment disposed generally opposite of the first charger compartment with respect to the cavity;
where the device charger is disposed within the first charger compartment and the second charger compartment.

4. The wireless device charging system to charge a wireless device as recited in claim 1, where the device charger comprises a first coil and a second coil.

5. The wireless device charging system to charge a wireless device as recited in claim 4, where the first coil and the second coil are disposed in an opposing arrangement, where the first coil is disposed at a first portion of the mobile receptacle and the second coil is disposed at a second portion of the mobile receptacle that is generally opposite of the first portion with respect to the cavity.

6. The wireless device charging system to charge a wireless device as recited in claim 1, where the charging position within the cavity corresponds to the wireless device being partially disposed within the cavity.

7. The wireless device charging system to charge a wireless device as recited in claim 1, where the charging position within the cavity corresponds to the wireless device being fully within the cavity.

8. A method comprising:
configuring a device charger with:
one or more coils;
a power component comprising a power storage, the power component to energize the one or more coils when the device charger operates in a charging mode; and
one or more interface ports configured to electrically connect to a power charging source to facilitate charging of the power storage;
disposing the device charger along one or more surfaces of a mobile receptacle, where the mobile receptacle forms a cavity adapted to at least partially receive a wireless device;
configuring the device charger to:
detect when the wireless device is disposed in a charging position within the cavity;
operate in a charging mode to use the power storage to charge the wireless device consequent to the detecting that the wireless device is disposed in the charging position;
detect when the wireless device is removed from the cavity; and
transition to a non-charging mode consequent to the detecting that the wireless device is removed from the cavity.

9. The method as recited in claim 8, where the device charger is disposed within one or more portions of the mobile receptacle.

10. The method as recited in claim 8, further comprising:
forming the mobile receptacle to have the cavity adapted to at least partially receive the wireless device;
forming the mobile receptacle to further comprise:
a first charger compartment; and
a second charger compartment disposed generally opposite of the first charger compartment with respect to the cavity;
where the device charger is disposed within the first charger compartment and the second charger compartment.

11. The method as recited in claim 8, where the device charger comprises a first coil and a second coil.

12. The method as recited in claim 11, where the first coil and the second coil are disposed in an opposing arrangement, where the first coil is disposed at a first portion of the mobile receptacle and the second coil is disposed at a second portion of the mobile receptacle that is generally opposite of the first portion with respect to the cavity.

13. The method as recited in claim 8, where the charging position within the cavity corresponds to the wireless device being partially disposed within the cavity.

14. The method as recited in claim 8, where the charging position within the cavity corresponds to the wireless device being fully within the cavity.

15. One or more non-transitory, machine-readable media having machine-readable instructions thereon which, when executed by one or more processing devices, cause the one or more processing devices to:
detect when a wireless device is disposed in a charging position within a cavity of a mobile receptacle, where the mobile receptacle forms a cavity adapted to at least partially receive the wireless device;
operate a device charger in a charging mode to use a power storage to charge the wireless device consequent to the detecting that the wireless device is disposed in a charging position, the device charger comprising:
one or more coils;
a power component comprising the power storage, the power component to energize the one or more coils when the device charger operates in the charging mode; and
one or more interface ports configured to electrically connect to a power charging source to facilitate charging of the power storage;
where the device charger is disposed along one or more surfaces of the mobile receptacle;
detect when the wireless device is removed from the cavity; and
transition the device charger to a non-charging mode consequent to the detecting that the wireless device is removed from the cavity.

16. The one or more non-transitory, machine-readable media as recited in claim 15, where the device charger is disposed within one or more portions of the mobile receptacle.

17. The one or more non-transitory, machine-readable media as recited in claim 15, where the device charger comprises a first coil and a second coil.

18. The one or more non-transitory, machine-readable media as recited in claim 17, where the first coil and the second coil are disposed in an opposing arrangement, where the first coil is disposed at a first portion of the mobile receptacle and the second coil is disposed at a second portion of the mobile receptacle that is generally opposite of the first portion with respect to the cavity.

19. The one or more non-transitory, machine-readable media as recited in claim 15, where the charging position within the cavity corresponds to the wireless device being partially disposed within the cavity.

20. The one or more non-transitory, machine-readable media as recited in claim 15, where the charging position within the cavity corresponds to the wireless device being fully within the cavity.
